(19) United States
(12) Patent Application Publication
(10) Pub. No.: US 2017/0344953 A1
(43) Pub. Date: Nov. 30, 2017

(54) METHOD AND SYSTEM FOR ORGANISING AND IDENTIFYING A SPORTS EVENT BASED ON USER'S INTEREST

(71) Applicant: Rachit AGGARWAL, Noida, Uttar Pradesh (IN)

(72) Inventor: Rachit AGGARWAL, Noida, Uttar Pradesh (IN)

(21) Appl. No.: 15/538,454

(22) PCT Filed: May 21, 2015
(86) PCT No.: PCT/IB2015/053739

§ 371 Date: Jun. 21, 2017

(30) Foreign Application Priority Data
Dec. 22, 2014 (IN) 3829/DEL/2014

(51) Int. Cl. G06Q 10/10; G06Q 50/00; G06Q 10/02

(52) U.S. Cl. CPC G06Q 10/109; G06Q 10/02; G06Q 50/01

(57) ABSTRACT

The present invention discloses a computer implemented method for organizing and identifying a sports event for a user based on user preferences in an online system having a plurality of players. The computer implemented method includes retrieving a preferred set of parameters corresponding to the user, retrieving at least one suitable player from a database comprising plurality of players, the at least one suitable player retrieved based on the user preferences and the set of parameters corresponding to the user, proposing the sports event to the user and the at least one suitable player and sending an invite to the at least one suitable player for playing the sports event with the user. Thereafter, the tickets are issued to the user and the players for playing the sports event. The tickets issued contain the preferred set of parameters.

### CROSS-REFERENCE TO RELATED APPLICATION

This application is the U.S. National Phase of PCT International Application No. PCT/IB2015/053739, filed on May 21, 2015. That application claims priority to Indian Provisional Patent Application No. 3829/DEL/2014, filed Dec. 22, 2014. The contents of both applications are herein incorporated by reference in their entirety.

### FIELD OF THE INVENTION

The present invention relates generally to method and system for organizing and identifying events more specifically sports events.

### BACKGROUND OF THE INVENTION

In present days, there has been a tremendous growth in number of people who are interested in sports. Sports have always been a matter of interest in youth. Right from young age to becoming adults, people play various types of games like cricket, soccer, etc. Various people have their own style of playing or have their own areas of interest for the games.

A person may prefer to bat than balling in a cricket match. In a soccer game, a person may have interest in goal keeping than in playing the match. It is always better to play the sports with different types of sportsperson which will help a person develop better gaming skills. The playing of sports is not merely limited to the people who take sports as a profession but a software professional may be interested in playing soccer on weekends. There are a variety of sports lovers varying from cricket fans, soccer fans, rugby fans and many more. However, for such kind of people it will be difficult to find out a team or similar players for organizing a weekend match program for instance.

For persons with busy schedule, who take keen interest in playing games, and who want to play games, it will be difficult to attend a fixed scheduled match at a particular location at a particular time. There is a need for a system for proposing a sports event to a person depending upon his preferences for playing the sports event. There is a constant need for a system where a person may find people who have similar sports interest. There is a need for a system which is capable of providing a suitable match or a sports event for a person for playing the game.

### SUMMARY OF THE INVENTION

The present invention aims to overcome the above mentioned limitations and other problems associated with the prior art.

The present invention discloses a computer implemented method for organizing and identifying a sports event for a user based on user preferences in an online system having a plurality of players. The computer implemented method includes retrieving a preferred set of parameters corresponding to the user, retrieving at least one suitable player from a database comprising plurality of players, the at least one suitable player retrieved based on the user preferences and the set of parameters corresponding to the user, proposing the sports event to the user and the at least one suitable player and sending an invite to the at least one suitable for playing the sports event with the user. Thereafter, tickets are issued to the user and the players for playing the sports event. The tickets issued contain the preferred set of parameters.

In an aspect of the present invention, the preferred set of parameters is location, date and time.

In an aspect of the present invention, the preferred set of parameters is entered by the user.

In an aspect of the present invention, the method includes calculating calculating reliability rating of the user based upon predefined criteria upon conclusion of the sports event.

In an aspect of the present invention, the reliability rating of the user is calculated on the basis of the user's attendance at the sports event and the user's responsiveness.

In an aspect of the present invention, the method includes sending of auto-invites to the players for attending the sports event.

In an aspect of the present invention, the method sends auto-invites to players who are who are physically located within a predetermined distance from the preferred location.

In an aspect of the present invention, the method sends auto-invites to players who have their location within 1 kilometer (KM) radius of the preferred location.

In an aspect of the present invention, the method sends auto-invites to the players who have their favorite venue within a predetermined distance of the preferred location.

In an aspect of the present invention, the method sends auto-invites to players who have their favorite venue within 1 kilometer (KM) radius of the preferred location.

In an aspect of the present invention, the method includes sending the auto-invites are sent when there are at least a predetermined number of idle users.

In an aspect of the present invention, the method includes initiating the auto-invite process if there are at least 8 idle users.

In an aspect of the present invention, the preferred location is a private venue.

In an aspect of the present invention, the preferred location is a home location of the user.

In an aspect of the present invention, the preferred location is a favorite venue of the user.

In another aspect of the present invention, the method includes performing a group search, wherein plurality of users search for players based on the predefined criteria.

In yet another aspect of the present invention, the method includes performing a replacement search to search for a replacement player when the retrieved at least one suitable player has cancelled participation to the sports event.

In yet another aspect of the present invention, the method includes maintaining a history of results of occurred sports event.

In yet another aspect of the present invention, the method includes receiving a checking in input from the user after the user reaches a venue for the proposed sports event.

In yet another aspect of the present invention, the invite is sent upon acceptance of the proposal by the user and the at least one suitable player.

These aspects together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawing and descriptive matter in which there is illustrated an exemplary embodiment of the present invention.

### BRIEF DESCRIPTION OF THE DRAWINGS

The advantages and features of the present disclosure will become better understood with reference to the following detailed description and claims taken in conjunction with the accompanying drawing, in which:

FIG. 1 illustrates various elements involved in the system as disclosed in the present invention, according to various embodiments of the present invention;

FIG. 2 illustrates a flowchart for the method for posting a search query, retrieving relevant results, sending invitation and calculating the reliability rating of the users according to various embodiments of the present invention;

FIG. 3 illustrated a flowchart for calculating the time slot while proposing a match or a sports event according to various embodiments of the present invention;

FIGS. 4a and 4b illustrate flowcharts for sending Auto-Invites to users according to various embodiments of the present invention;

FIG. 5 illustrates a flowchart for auto starting of Auto-Invite process according to various embodiments of the present invention;

FIGS. 6a and 6b are user interface examples for finding a match by a user, according to various embodiments of the present invention;

FIG. 7 is a user interface example for a Home Location, according to various embodiments of the present invention;

FIG. 8 is a user interface example for a Favorite Venue, according to various embodiments of the present invention;

FIG. 9 is a user interface example for a Private Venue, according to various embodiments of the present invention;

FIG. 10 is a user interface example for a Match Ticket, according to various embodiments of the present invention;

FIG. 11 is a user interface example for forwarding of an Auto-Invite by a user to a player, according to various embodiments of the present invention; and

FIG. 12 is a user interface example for updating the match result by a user, according to various embodiments of the present invention

Like numerals refer to like elements throughout the present disclosure.

### DETAILED DESCRIPTION OF THE INVENTION

The exemplary embodiments described herein for illustrative purposes are subject to many variations in structure and design. It should be emphasized, however, that the present invention is not limited to a computer implemented method for organizing sports events. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced item.

The terms “having”, “comprising”, “including”, and variations thereof signify the presence of a component.

The present invention relates to a computer implemented method for providing a suitable player to a user for organizing and playing a sports event in for example, real world.

More specifically, the computer implemented method is adapted to allow various people existing on social media networks or online social networking platforms to play sports event in real world.

The term “sports event” refers to any kind of sports preferred by a user like cricket, soccer, badminton, and the like, although various embodiments of the present invention may be explained with reference to a computer implemented method for organizing and playing soccer. The present invention provides ways and means for proposing a suitable sports event to a user by finding or locating at least a suitable player for playing and organizing a sports event at a physical location.

The present invention provides a suitable sports event to a user based on user's requirements for organizing and playing a sports event. In various embodiments, the user can find a sports event via a computer, a web browser, a mobile device (tablet or smartphone), smart TV, wearable technology, or virtual reality system but not limited to these computational devices.

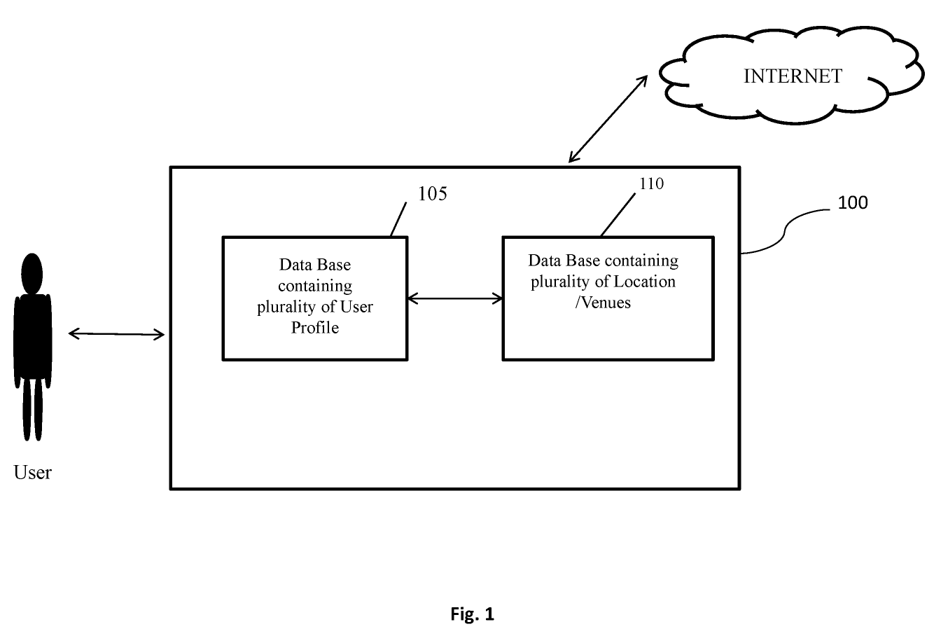

The present invention provides an application 100, which will allow interactive searching for finding one or more suitable players for a sports event. The computer implemented method embodied therein is explained below in conjunction with FIGS. 1-5.

For the proof-of-concept, the present invention provides an online social platform (hereinafter interchangeably called as “GamePlan” or “platform” or “system”) for sport lovers live soccer fans, cricket fans, rugby fans, basketball fans and many more, where anyone can register himself and be a part of a team. This platform provides various options to multiple users for interacting with each other and users can make friends and friend list. The system provides a login with Facebook or create an account.

As illustrated in FIG. 1, the system contains a database 105 of user profiles and another database 110 for a list of physical locations. When a user searches for a suitable sports event, the application runs a query and searches the database 105 in conjunction with database 110 for finding the players who have posted similar queries and who want to play a game with similar preferences as the user. Once the system finds the appropriate number of players then the system proposes the sports event to the user and the other found players and issues match tickets to them. The user can also add/register a location to the list and this will be visible to other users. User can also add pictures of the location, leave comments and give ratings to the location. A user interface of a Match ticket from the system is shown in FIG. 10 of the accompanying drawings.

In one embodiment, the system 100 is also capable of proposing a match or a sports event by selecting a number of persons/players from pool based on their preferences as described in the succeeding description.

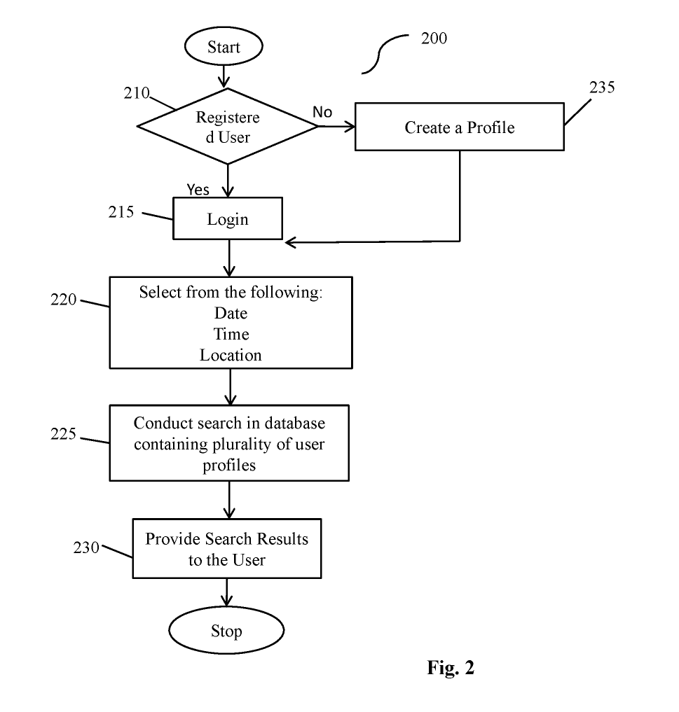

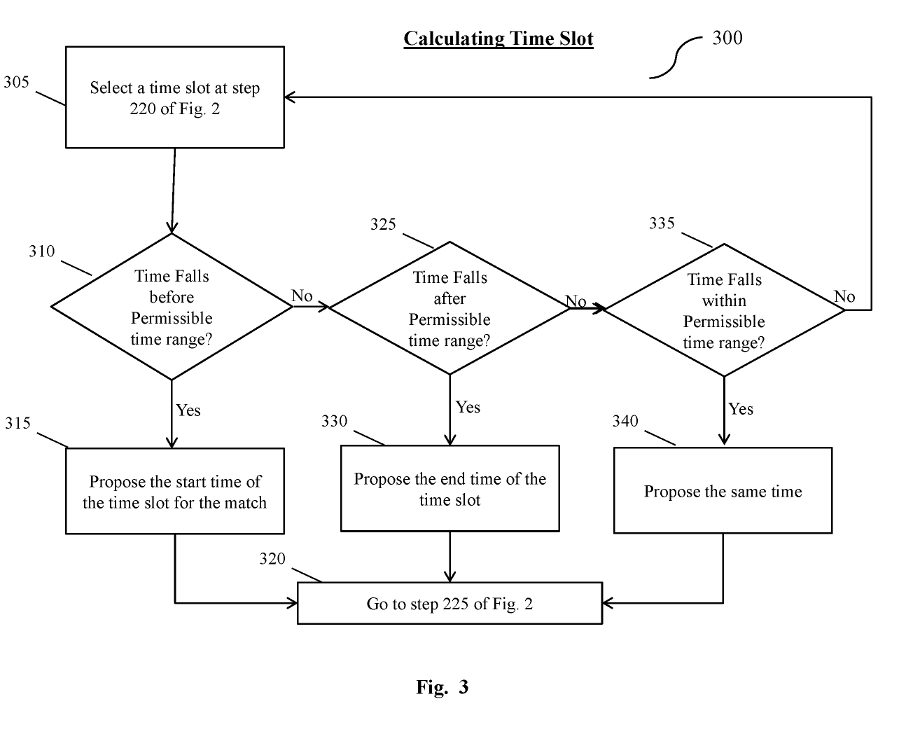

FIG. 2 illustrates a flowchart regarding the computer implemented method 200. The method starts at step 200. At step 210, if the user is a registered user, the user will login to the system with his Facebook account or already created account with the application at step 215. If the user is not a registered user, the method flows to step 235 for creating a profile with desired credentials and thereafter the user is allowed to login to the system.

At step 215, the user is required to login to the system. The user may login using his Facebook account. The user can maintain his own profile in the system. The profile of the user includes parameters such as name, age, e-mail, country, state, city, pin code, phone, status, display picture, favorite club, favorite position, favorite player, experience etc. Each user is able to maintain his/her own profile with the option to edit personal details and also upload display pictures.

The following information are shown as the profile information to the Public: name, age, e-mail, country, state, city, pin code, phone, status, display picture, favorite club, favorite position, favorite player, experience, matched played, rating and reliability rating.

In an embodiment of the present invention, the user has option to edit basic settings such as sounds, notifications etc.

a. Notifications On/Off

b. Alert Sounds (Messages/Notifications)

Once the user logs in to the system, the user can search for one or more suitable players for playing and organizing a sports event. At step 220, the user selects the options such as date, time of the sports event and the location where the sports event will take place. This methodology of selecting date, time and location will be explained in detail in conjunction with FIG. 3.

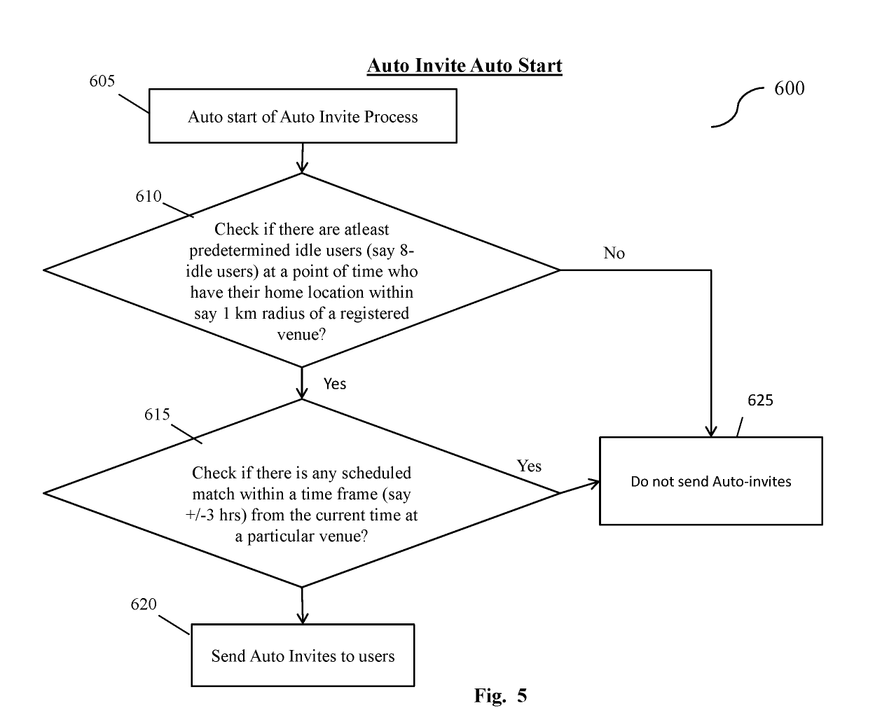

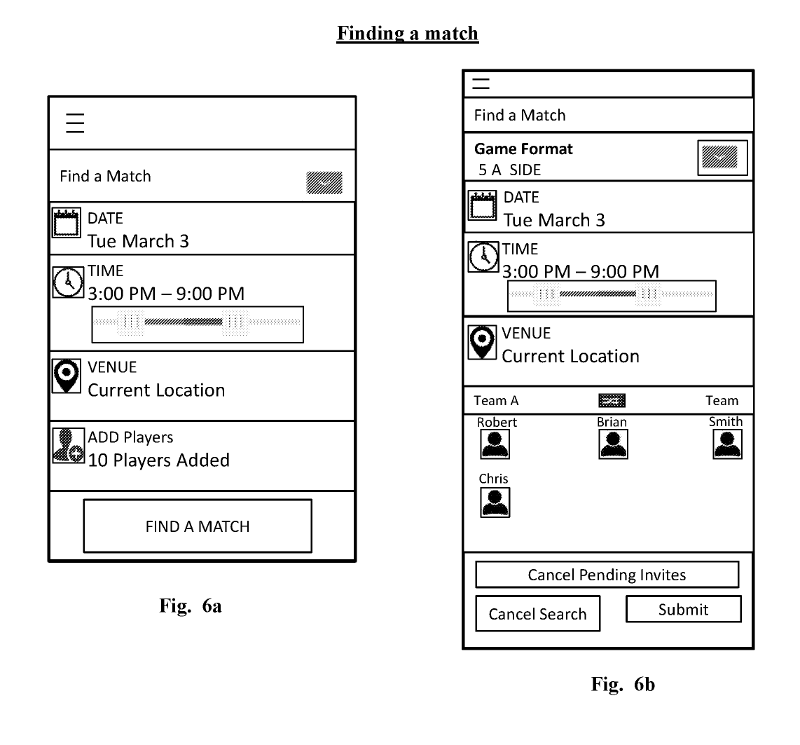

Once the user inputs the details, the system conducts a search in its database at step 225 of the method and provides the results to the user at step 230 of the method. The system provides a list of other users/players who are ready to play a match or sports event and the list is based on user preference and pre-defined criteria. User can choose the team player according to his convenient by checking their profile. User needs to select a particular date while posting the query. In case this means the date has to be changed to the next day for a particular time selection, and then the system automatically performs the action on the next date. User can also select from pre-registered venues/locations from fully functional map feature (like Uber). In addition to the above, system 100 uses the information such as age and gender of the user. A user profile contains user general skill level, play style and technical capabilities which are used in matchmaking to provide perfect player for the sports event, allowing a user to choose based upon play style, general skill level, and/or technical capabilities. A user interface example of inputting a query for finding a match or a sports event is provided in FIGS. 6a and 6b.

In an embodiment of the present invention, the user is required to input date which must be a future date. The user has the option of selecting multiple dates from the calendar.

Further to that, the user is required to select the time at which the user wants to play the sports event. The user is required to enter a time slot during which he wants to play a match or a sports event. The length of the time slot is taken as a minimum of 3 hours and a maximum of 6 hours. The explanation becomes clearer in conjunction with FIG. 3.

Once the user inputs his preferred parameters like date, time and location, then the system adds 90 minutes to the current time at step 305 and if the time falls before the permissible time range at step 310, then the system proposes the start time of that range as at step 315. If the time falls outside of the permissible range at 320, then the system proposes the end time of the range as in step 325. Further at 330, if the time falls within the permissible time range, then the system proposes that time only as in step 335. Optionally, the system calculates the nearest 15 minutes to get the exact time to propose a match or sports event to the user. When the user selects a particular date, then all the time selections are considered for future time only.

In an embodiment of the present invention, the user is required to select a location for the match or sports event. The system provides various options to the user, such as the user can select from a list of pre-registered locations or the user can select from his favorite location/venue list or lastly the user can select a location from a fully functional map like UBER maps, and the like. A user interface from the system is shown in FIG. 8 of the accompanying drawings.

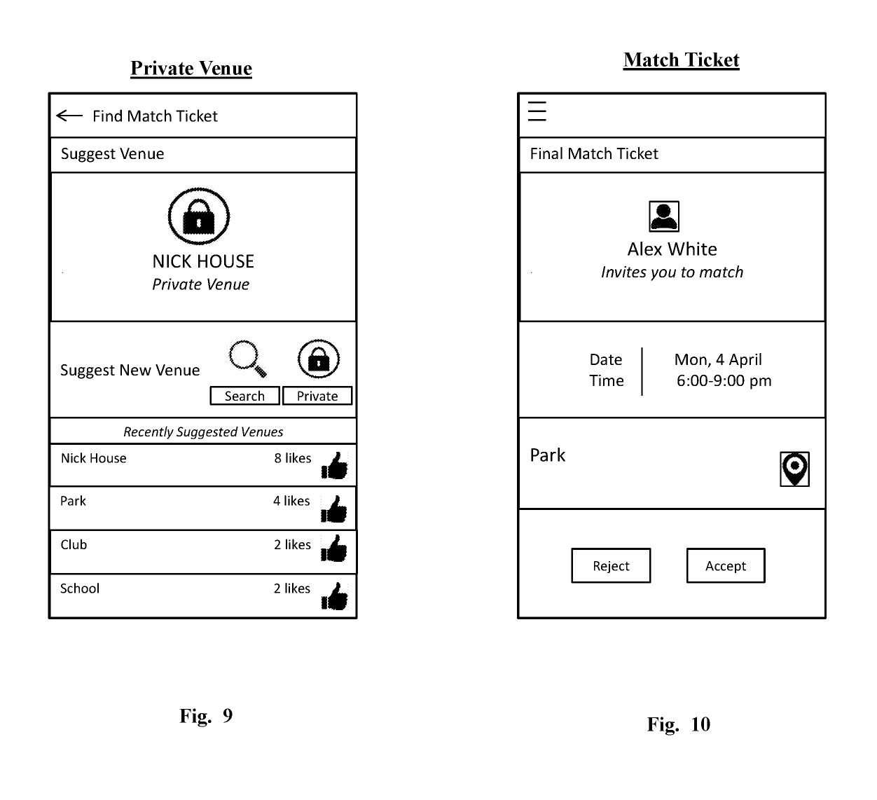

The user also has the option of mentioning a “Private Venue”. For example, if a user owns a playground and wants to organize a match at the playground and does not want the location to become publicly known, then the user has the option to tag the venue as “Private Venue”. In such cases, it is completely on the user to communicate the location or the address of the Private Venue to his team members for a particular sports event. A user interface from the system is shown in FIG. 9 of the accompanying drawings.

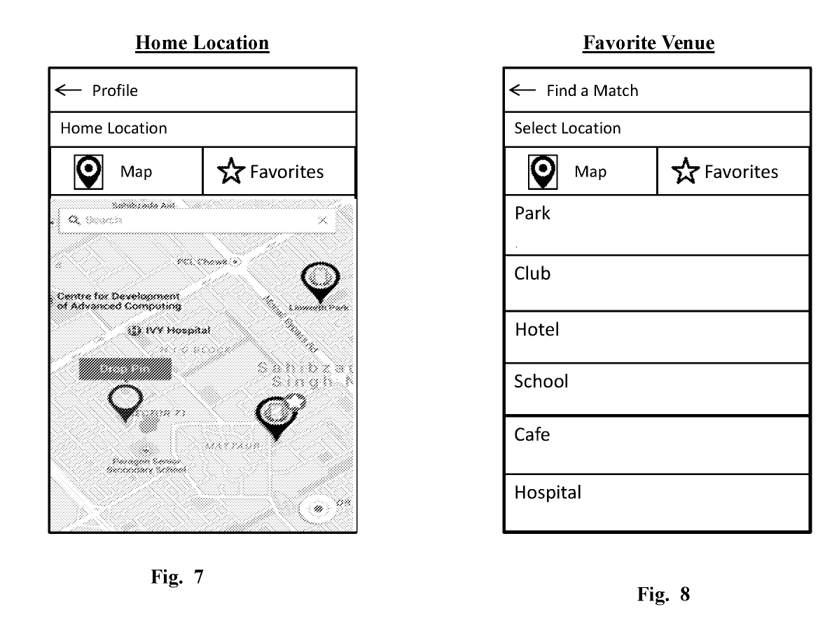

In an embodiment of the present invention, the user can select some location where he plays the most as his “Home Location”. A user interface from the system is shown in FIG. 7 of the accompanying drawings.

In an embodiment of the present invention, the system is capable of suggesting or recommending a venue or a location which is the most suitable for a sports event depending upon the selection of players for the sports event.

While conducting the search, the system also uses the information like the age and gender of the user in order to provide the relevant results or suitable match or sports event to the user.

In an embodiment of the present invention, the user cannot have more than one pending search at any given time. As long as a Query is in progress, the user cannot post another. The user can edit the match or sports event preferences at any time before the search and system accommodates those changes and propose a match or sports event accordingly. Once a match or sports event is proposed and accepted, the user cannot change it. In a case, where the user rejects the match or sports event, then the user has to post the query again. Additionally, the user has the option to cancel the search at any point of time.

In an embodiment of the present invention, the system 100 also provides the user for conducting a search for finding more than one suitable match or sports event or more than one suitable player for a match or a sports event. The user can invite multiple players for his match or sports event. When the user starts entering the name, results will start populating on its own after a minimum of 3 characters are typed in. The user can also invite one or more members of his group. When a user posts a search query, the user is unable to invite anyone if time range of the proposed match coincides within +/−3 hours of a pre-scheduled match or sports event of the targeted person. Further, the user does not get the option for inviting himself from the list. The user has the option to divide the invited players between Team A and Team B as per his choice. The user can divide players into teams as per the selected format only.

In an embodiment of the present invention, the system 100 and method 200 provide the user with an option to invite other players to join his match or sports event and initiate a group search to find the balance players instead of an individual search as explained above. As soon as a user/player selects this option, he is prompted by the system 100 to first select his preferred format of the match or sports event. The user can keep on inviting as many people he wants from his Friend List. The user has the option to divide the invited users/players between Team A and Team B as per his choice. If the number of users/players invited is more than the format selected, then the user is informed that acceptation of the invitation is based on first come first serve basis and initiate the match once sufficient people have accepted your invitation as per the format selected. Additionally, the user has an option to cancel any pending invitations. In case the number of players who have accepted the invitation is less, then system searches and finds more players for the user.

In an embodiment of the present invention, when a user performs a group search, the user along with other selected players will group together for a particular scheduled match or sports event. Once the teams are finalized by the user, the team distribution will remain the same and cannot be amended. The finalization of the group and fixing of a match or sports event will not be done until all the invitations are accepted or rejected or cancelled. Additionally, even if only one invitation is pending the match or sports event is not scheduled. Further, the system is capable of matching two different group searches against each other and can present only one suitable match or a sports event to the user.

In an embodiment of the present invention, the system is capable of distributing the players into teams and proposing the sports event.

In an embodiment of the present invention, the system 100 sends auto-invitations to relevant users/players. When the user posts a search query whether it is for an individual search or a group search, the system 100 sends auto-invites to relevant users/players. The user has an option to turn On/Off this option.

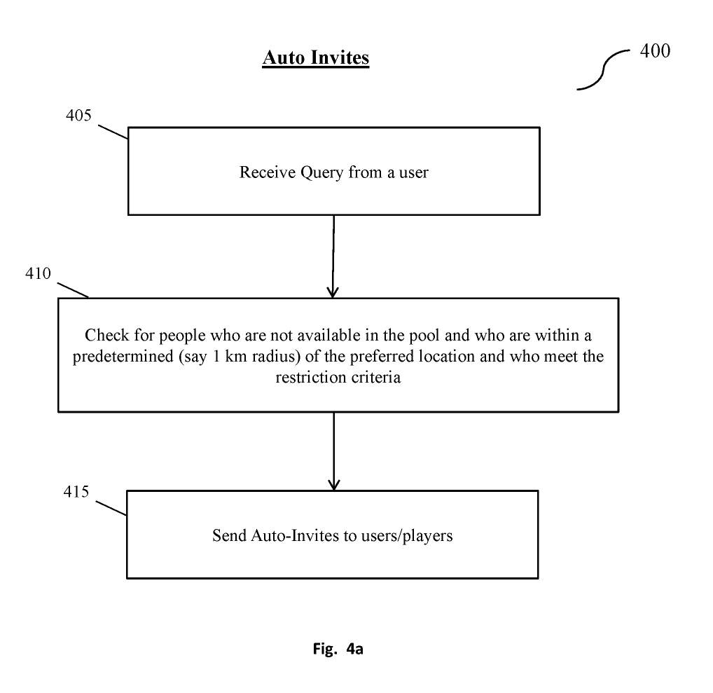

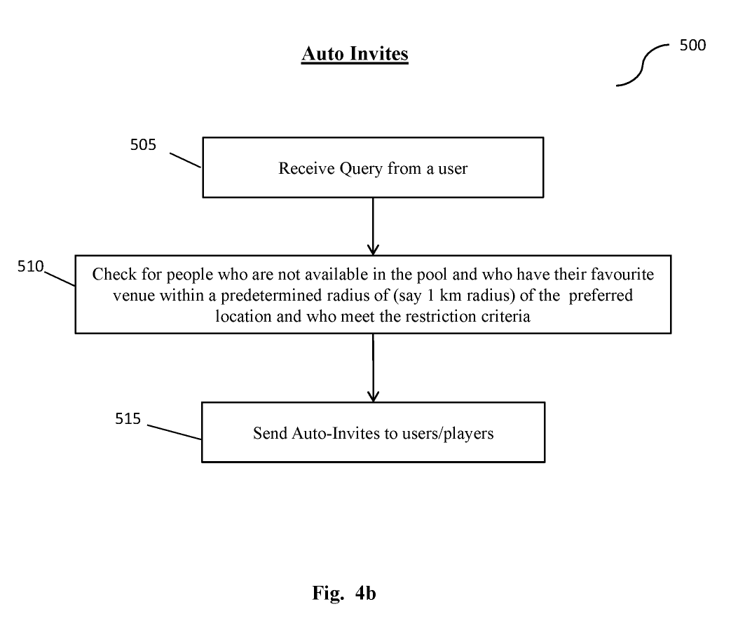

In an embodiment of the present invention, as illustrated in FIGS. 4a and 4b, the system 100 sends auto-invites to users/players based on following:
a. Players/Users who are not in the available list and who meet the criteria as defined by the system and who has their Home Location within a 1 KM radius of the user's preferred venue/location
b. Players/Users who are not in the available list and who meet the criteria as defined by the system and who has a favorite venue within a 1 KM radius of the user's preferred venue/location

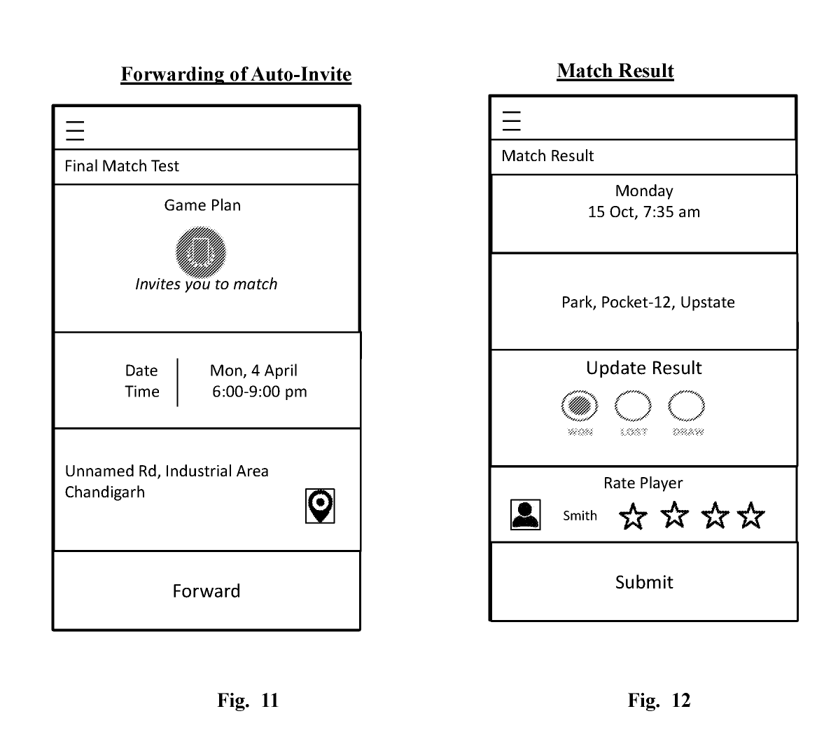

A user who has received an invitation from another user, can forward the same invite to his friends, but only after he himself has accepted it. A user interface example of such forwarding by a user has been shown in FIG. 11 of the accompanying drawings.

A user who has received an invitation from another user, cannot forward the same to another user/player if the time range for the proposed match or sports event coincides within +/−3 hrs of a pre-scheduled match or sports event of the targeted person.

In an embodiment of the present invention, the system 100 is configured in such a way that an auto-invite will not be sent:
a. if a user has previously rejected a Match or sports event for a common time range for that date
b. if the preferred time range of the auto-invite coincides within +/−3 hrs of a previously scheduled match or sports event of the user

In a preferred embodiment of the present invention, the system 100 initiates the auto-invite process even when no search is being conducted in the system.

In an embodiment of the present invention, when the system 100 is performing an individual search, after a waiting time of two minutes, if sufficient number of invitations is accepted, a sports event or a match is proposed and the remaining invitations expire or cease.

In an embodiment of the present invention, when the system 100 is performing group search, the system 100 will wait for the required numbers of invitations to be accepted in accordance with the prior set format, and then propose immediately.

The Auto-Invite process works parallel to the search process of the system 100. As soon as a user/player accepts an auto-invite, the system 100 adds the user/player to all the possible squads of that group. The system 100 is further configured to delete the least scoring member from all squads of that group. Once the deletion is done, the system continues to search for the balance players.

During the period search is being conducted, if the system 100 finds a good match or player for the user, it decides to propose a same to the user and then the auto-invite expires and a ticket is issued to the player/user for the sports event.

In case a user tries to accept an expired auto-invite, then the user is asked if he would like to schedule another match or sports event. If the user agrees to schedule another match or sports event, then the system 100 directs him to finding a player with the Auto-Invite details pre-filled (only if they are still valid). If however, sufficient auto-invites are accepted as the logic explained above, then the system stops the search and ticket is issued for the sports event.

A user can only have one single auto-invite pending in his notifications at any given time. In case, he/she becomes eligible for another invitation while this invitation is still pending then he/she will not get that invitation.

In case the user ignores to respond to this invitation and goes directly to find a match or a sports event, then he will first be asked to respond to this invitation and only then he can proceed further.

In case the user cancels the search after the auto-invites are sent then:
i. the invitations remain active for due-course and is processed as normal
ii. the system will find the remaining players for those who have accepted the auto-invite

However, if at any point of time there are no sports events, then the auto invite will expire. Auto-Invite process has the capability to auto-start on its own without any formal search on the system 100.

In an embodiment of the present invention, the system 100 initiates the auto-invite process as soon as the system detects for atleast 8 idle users with their home locations within 1 Km radius of any registered location/venue on the system at step 610 as illustrated in FIG. 5. Thereafter, the system checks if any location/venue has a Match or sports event already scheduled at +/−3 hours of the scheduled Match or sports event at step 615. If to the affirmative, the system 100 does not initiate the Auto-Invites for +/−3 hours of the scheduled Match or sports event at step 625. Otherwise, the system initiates the auto-invite process and starts sending auto-invites to the users at step 620.

While performing a group search, the auto-Invite loop considers the already registered venue, current date and time slot is calculated as next 6 hours starting from nearest next 30 minutes.

The auto-start of auto-invite process does not happen on any day after 4 pm and before 12 noon.

In an embodiment of the present invention, the system 100 is capable of performing a replacement search when a user/player leaves an already scheduled match or sports event after match or sports event has become active. System 100 is configured to send auto-invites along with giving option to other players/users to send invites and the system 100 starts its replacement search for finding replacement players.

In such scenario, auto-invites are sent to users/players—
a. Players/Users who are not in the available list and who meet the criteria as defined by the system and who has their Home Location within a 1 KM radius of the user's preferred venue/location as illustrated in FIG. 4a.
b. Players/Users who are not in the available list and who meet the criteria as defined by the system and who has a favorite venue within a 1 KM radius of the user's preferred venue/location as illustrated in FIG. 4b

In case if the Current Venue location is “NA” or “Private”, then Auto-Invites are not sent to the users/players.

In case there are users/players that have already rejected an auto-invite for the same match or sports event, then this time auto-invite will not be sent to them.

In an embodiment of the present invention, the system 100 does not send the Auto-invite to the following:
a) If a user has previously rejected a Match or sports event for a common time range for that date
b) If the preferred time range of the auto-invite coincides within +/−3 hrs of a previously scheduled match or sports event of the user.

In case, when a user receives an invitation for the same match or sports event by another user and also an auto-invite then the auto-invite is removed and other user's invitation will remain in the notification box.

In case, if a user/player had rejected the auto-invite but has been invited again by someone for the same match or sports event, then the new invitation is shown to the user.

In case, if a user/player had rejected the invitation for the same match or sports event previously sent by another user, then system 100 does not send the auto-invite to him.

In an embodiment of the present invention, the system 100 is capable of recommending venues/locations for a particular match or sports event. Once the selection of players is complete, the system 100 recommends a location for playing the match or sports event. In order to calculate, the system 100 finds a centroid point taking into consideration the preferred location coordinates of all the users in the squad. From the centroid point, the system 100 searches for a nearest venue from the database within the 2 KM radius. The system 100 does not recommend any Venue which falls outside the permissible Location restriction of any user.

In case when the system 100 is unable to find any such venue, then the system 100 shows NA under the recommended venue.

The system does not recommend a venue if there is another match or sports event organized at same venue within +/−3 hours of the scheduled date & time.

The present invention will now be explained with reference to a specific scenario, wherein a user searches for a player for playing a sports event.

In an embodiment of the present invention, if there is an exact player found for a particular parameter as per the user's preferences, then a score of 1.01 including an additional score of 0.01 is given to the user. The additional score of 0.01 is given to that particular parameter for that user only. Below is a table with category and age details:

| | |
|---|---|
| CATEGORY | AGE |

| Category | From | To |
|---|---|---|
| Junior | Below | 13 |
| Senior | 14 | 18 |
| College | 19 | 24 |
| Working | 25 | 50 |
| Retired | 51 | 50 |

In the case of a group search, the additional score is added individually to all the group members.

Below is table briefing the Overall Priority Chart:

OVERALL PRIORITY CHART

| | Junior | Senior | College | Working | Retired |
|---|---|---|---|---|---|
| Gender | 2 | 3 | 3 | 2 | 1 |
| Age | 3 | 2 | 2 | 2 | 3 |
| Date | 1 | 2 | 1 | 3 | 1 |
| Time | 1 | 2 | 1 | 3 | 1 |
| Location | 3 | 3 | 2 | 3 | 3 |
| Position | 1 | 2 | 2 | 1 | 1 |
| Format | 2 | 2 | 1 | 2 | 2 |

Below is a table showing the Restrictions:

RESTRICTIONS

| | Location (KMs) | | Date (Days) | | Time (mins) | | Format | |
|---|---|---|---|---|---|---|---|---|
| | Lower | Upper | Lower | Upper | Lower | Upper | Lower | Upper |
| | Limit | Limit | Limit | Limit | Limit | Limit | Limit | Limit |
| Junior | −1 | 1 | Selection | Selection | Selection | Selection | 4 | 7 |
| Senior | −1.5 | 1.5 | Selection | Selection | Selection | Selection | 4 | 8 |
| College | −4 | 4 | Selection | Selection | Selection | Selection | 4 | 9 |
| Working | −2 | 2 | Selection | Selection | Selection | Selection | 4 | 8 |
| Retired | −3 | 3 | Selection | Selection | Selection | Selection | 4 | 7 |

The format restrictions can only be over-ridden in case of a group search when a user specifically demands for a particular format and also invites as many people accordingly.

The fixing of date depends on the user preference. The system scores those users/players only who fall in a common date selection.

The fixing of time also depends on the user preference. The user has to select a time which does not fall within +/−3 hours of an already scheduled Match or sports event.

In case of multiple invitations pending for a user, then also a user cannot accept any two matches or sports events within +/−3 hours of scheduled time.

The system 100 adds scores to the users/players who fall in the common time selection slot.

In a case when the system 100 is still looking for a player and the preferred time range has already started, then the system automatically ignores the time that has gone by already and continue to look within the remaining time. This may lead to the rejections of many possible combinations.

The system 100 always keeps a gap of at least 30 minutes from current time.

The system 100 does not allow the user to select a time range overlapping the +/−3 hours of any previously scheduled match or sports event.

In a scenario when the date is changing because of the time range selection, but the time range is still common, the system 100 accepts the time and date selected.

The following description and the table below show a list of different categories of users and the scores given to them by the system in a particular case depending on the location of the users from the preferred match or sports event venue:

LOCATION

| | | | | | | | | Above |
|---|---|---|---|---|---|---|---|---|
| | 0-0.24 KM | 0.25-0.49 KM | 0.5-0.99 KM | 1-1.99 KM | 2-2.99 KM | 3-4.99 KM | 5-7.99 KM | 8 KM |
| Junior | 1 | 0.75 | 0.5 | 0.25 | 0 | 0 | 0 | 0 |
| Senior | 1 | 1 | 0.75 | 0.75 | 0.5 | 0.25 | 0 | 0 |
| College | 1 | 1 | 1 | 1 | 0.75 | 0.75 | 0.5 | 0.25 |
| Working | 1 | 1 | 1 | 0.75 | 0.5 | 0.5 | 0.25 | 0 |
| Retired | 1 | 1 | 1 | 0.75 | 0.75 | 0.5 | 0.25 | 0.25 |

The above scores are multiplied by the exact percentage of the squad falling into a particular location tolerance category.

The distance between two points is calculated as the straight line distance between the Lat/Long of both the locations and not the Google maps travelling distance.

While searching for a user/player, the system gives a score of “1” for a same gender squad. In case of a mixed gender squad, the system follows the below table:

GENDER

| | |
|---|---|
| Difference between | Difference between the differences of |
| Male to Female | Male and Female in each team |

| in Squad | 0 | 2 | 4 | Above 4 |
|---|---|---|---|---|
| 0 | 0.75 | 0.5 | 0.25 | 0 |
| 2 | 0.75 | 0.25 | 0 | 0 |
| 4 | 0.5 | 0.25 | 0 | 0 |
| Above 4 | 0.25 | 0 | 0 | 0 |

Below is a table for Parameter Weighting:

| Parameter | Weight |
|---|---|
| Age Tolerance | 0.4 |
| Average Differential | 0.3 |
| Standard Deviation Differential | 0.3 |

Below is a table for Individual Age Tolerance Chart:

| | | | | | 10 |
|---|---|---|---|---|---|
| | +/−3 | +/−5 | +/−7 | +/10 | Above |
| 8-10 | 1 | 0.5 | 0 | 0 | 0 |
| 11-13 | 1 | 0.5 | 0 | 0 | 0 |
| 14-16 | 1 | 0.5 | 0.25 | 0 | 0 |
| 17-19 | 1 | 0.75 | 0.5 | 0.25 | 0 |
| 20-22 | 1 | 0.75 | 0.75 | 0.5 | 0.25 |
| 23-29 | 1 | 1 | 0.75 | 0.5 | 0.25 |
| 30-36 | 1 | 1 | 1 | 0.75 | 0.5 |
| 37-50 | 1 | 1 | 1 | 1 | 0.75 |
| 51 above | 1 | 1 | 1 | 1 | 1 |

The system 100 multiplies the above score by the exact percentage of the squad falling into a particular location tolerance category.

Below is a table for Individual Team Average Difference Score Chart:

| | 1 | 0.75 | 0.5 | 0.25 | 0 |
|---|---|---|---|---|---|
| 8-10 | 0-1 | 1.1-2 | 2.1-4 | 4.1-6 | 6.1 above |
| 11-13 | 0-1 | 1.1-2 | 2.1-4 | 4.1-6 | 6.1 above |
| 14-16 | 0-2 | 2.1-4 | 4.1-6 | 6.1-7 | 7.1 above |
| 17-19 | 0-3 | 3.1-5 | 5.1-7 | 7.1-8 | 8.1 above |
| 20-22 | 0-4 | 4.1-6 | 6.1-8 | 8.1-9 | 9.1 above |
| 23-29 | 0-5 | 5.1-7 | 7.1-9 | 9.1-10 | 10.1 above |
| 30-36 | 0-6 | 6.1-8 | 8.1-10 | 10.1-11 | 11.1 above |
| 37-50 | 0-8 | 8.1-10 | 10.1-11 | 11.1-12 | 12.1 above |
| 51 above | 0-9 | 9.1-11 | 11.1-13 | 13.1-15 | 15.1 above |

Below is a table for Individual team Standard Deviation Difference Score Chart:

| | 1 | 0.75 | 0.5 | 0.25 | 0 |
|---|---|---|---|---|---|
| 8-10 | 0-1 | 1.1-2 | 2.1-3 | 3.1-4 | 4.1 above |
| 11-13 | 0-1.5 | 1.6-2.5 | 2.6-3.5 | 3.6-4.5 | 4.6 above |
| 14-16 | 0-2 | 2.1-3 | 3.1-4 | 4.1-5 | 5.1 above |
| 17-19 | 0-3 | 3.1-4.5 | 4.6-5.5 | 5.6-6 | 6.1 above |
| 20-22 | 0-4 | 4.1-5.5 | 5.6-6..5 | 6.6-7 | 7.1 above |
| 23-29 | 0-5 | 5.1-7 | 7.1-8 | 8.1-9 | 9.1 above |
| 30-36 | 0-6 | 6.1-8 | 8.1-10 | 10.1-12 | 12.1 above |
| 37-50 | 0-7 | 7.1-9 | 9.1-11 | 11.1-13 | 13.1 above |
| 51 above | 0-8 | 8.1-10 | 10.1-12 | 12.1-14 | 14.1 above |

Below is a table for selecting a match or sports event Format:

FORMAT

| | 4 | 5 | 6 | 7 | 8 | 9 | 10 | 11 |
|---|---|---|---|---|---|---|---|---|
| Junior | 0.75 | 1 | 0.5 | 0.25 | 0 | 0 | 0 | 0 |
| Senior | 0.5 | 0.75 | 1 | 0.75 | 0.25 | 0 | 0 | 0 |
| College | 0.5 | 0.75 | 1 | 0.75 | 0.5 | 0 | 0 | 0 |
| Working | 0.5 | 0.75 | 1 | 0.5 | 0.25 | 0.25 | 0 | 0 |
| Retired | 0.75 | 1 | 1 | 0.25 | 0 | 0 | 0 | 0 |

In case of a group search, format for the player selected by the user who is conducting the search is taken as the only format for the player and is given to the group.

Also as mentioned above under restrictions, in this particular case the format restrictions will be relaxed. For example, if the system puts a restriction on a junior player to play in a match format of 4×4 and not 8×8, and the junior player accepts an invitation to play a match of 8×8 format, then the system allows the junior player to be a part of such match and play with other players. The system is flexible in such scenarios regarding the format restriction.

In a particular scenario, the following scores are given to the users depending upon the Position from where the users/players opt to play a match or sports event:

POSITION

| | Goalkeeper | Defender | Mid-Fielder | Striker |
|---|---|---|---|---|
| Junior | 0.5 | 0.75 | 1 | 1 |
| Senior | 0 | 0.75 | 0.75 | 1 |
| College | 0 | 0.75 | 0.75 | 1 |
| Working | 0.25 | 0.5 | 0.5 | 1 |
| Retired | 0.5 | 0.5 | 0.5 | 0.5 |

Below is a table for Formation:

FORMATION

| | (Priority | | | Mid- | |
|---|---|---|---|---|---|
| Format | Wise) | Goalkeeper | Defender | Fielder | Striker |
| 4 | 1 | 0 | 1 | 2 | 1 |
| 5 | 1 | 1 | 1 | 2 | 1 |
| 6 | 1 | 1 | 2 | 2 | 1 |
| | 2 | 1 | 2 | 1 | 2 |
| 7 | 1 | 1 | 2 | 2 | 2 |
| | 2 | 1 | 2 | 3 | 1 |
| | 3 | 1 | 3 | 2 | 1 |
| 8 | 1 | 1 | 3 | 2 | 2 |
| | 2 | 1 | 3 | 3 | 1 |
| | 3 | 1 | 2 | 3 | 1 |
| 9 | 1 | 1 | 3 | 3 | 2 |
| | 2 | 1 | 3 | 4 | 1 |
| | 3 | 1 | 4 | 3 | 1 |
| 10 | 1 | 1 | 4 | 3 | 2 |
| | 2 | 1 | 4 | 4 | 1 |
| | 3 | 1 | 3 | 3 | 3 |
| 11 | 1 | 1 | 4 | 3 | 3 |
| | 2 | 1 | 4 | 4 | 2 |
| | 3 | 1 | 4 | 5 | 1 |

FORMAT PRIORITY SCORE

| Priority | Score |
|---|---|
| 1 | 1 |
| 2 | 0.5 |
| 3 | 0.25 |

In an embodiment of the present invention, the system proposes a match or sports event based upon the following criteria:
a. After every minute, the system checks for the following criteria and if anyone of them is satisfied, then accordingly a Match or sports event is proposed by the system:

MATCH PROPOSAL

| Minimum Squad | Minimum Individual | Waiting |
|---|---|---|
| Score | Score | Time |
| 85% | NA | Immediate |
| 75% | 65% | 2 |
| 65% | 55% | 4 |
| 60% | 50% | 6 |
| 50% | 40% | 10 |
| 0% | 0 | 15 |

b. Highest scoring squads are also proposed in case all the calculations are done and the system stops receiving any new queries

In case if the system is unable to find a player even after 15 mins, then the system provides the user with No player was found so far but the system continues to look for it and get back to them as and when it is found.

In case if the system is unable to find a match or sports event even after the scheduled date and time have already passed, then the system cancels the Match/Query and reverts to the user for requesting another query for another date.

After the system has completed the search, the system generates tickets to the users/players. The match ticket includes all the following details of the Match or sports event:
a) Date
b) Time
c) Preferred Venue
d) Format
e) Player Names with Team Distribution (team Red v/s Team Blue)
f) Position

In an embodiment, the system saves the time taken for the player to be found and also the score of the player for this an occurred sports event for future analysis.

Once the tickets are issued, a user can also view the profile of the squad players.

Users are able to chat with each other now for this sports event.

Once the chatting among the users begins, the users may optionally suggest different venue locations for the match or sports event. In case, if the squad decides of a particular venue which already has a prescheduled match or sports event within +/−3 hours of the Match or sports event time, then the system provides the information to the users regarding the prescheduled match or sports event. Users can select the venue from the registered venues, favorite venues or “Private”.

A user can suggest a maximum of two match or sports event venues at any given time.

The system provides the users with the option of “Liking” a venue. Each user can “Like” any one of the Venues from the list of total suggested venues. In case, a user wants to like one more venue then automatically his previous like is removed by the system.

A user cannot like his own suggestion.

As soon as any particular suggested venue receives 33% of the total votes available at any time, it gets automatically updated in the Match or sports event ticket. After this, all the remaining suggested Venues will also be removed from the list.

Any user can again suggest any venue and the same loop will continue endlessly.

In case any user leaves the match or sports event, then his suggestions will still remain. However, his like is removed.

In case, no venue is updated and even the recommended venue is NA, then the system takes it as a Private venue.

In this case, the Venue will also be updated as “Private” after the Match or sports event.

When a user views a suggested venue then the system provides directions from the user's location to the venue like Google maps.

Once a match or sports event has taken place, the system asks each user to share the Match or sports event result along with rating of the other player. A user interface of such updating of match result by a user after the occurrence of match or a sports event in FIG. 12 of the accompanying drawings.

After all the ratings are received, then any Match or sports event result with maximum score is declared as the final result provided it is also at least the choice of 33% of the total users who rated and voted.

It is only if the above condition is satisfied will the Match or sports event result be updated otherwise it will show as “No Result”

Once the Match or sports event result status is declared, it cannot be changed under any circumstances.

In case, if any or all of the Match or sports event result notifications are still pending even after 3 hours, then either the Match or sports event result is declared if sufficient majority is achieved as per the defined logic (at least ⅓^{rd} people saying one common result) or else it is declared as No result. In any case, the pending notifications will expire.

A person can organize another match or sports event, even if he has not responded to the match or sports event result/player rating notification of the previous match or sports event.

Match or sports event result will have the following options: Won/Lost/Draw

A user can cancel a match or sports event after acceptance of an invitation (Auto-Invite/Group Invite) but before the Match or sports event gets active. In this case:
I. From all the Squads formed by the system, that particular leaving person would be immediately removed
II. Along with this person, the user who will be lowest scoring in that particular squad is also removed in order to balance the teams
III. However, if the squad auto-rebalances then the system may not remove anybody. Like in the case of a Group search in which when the user performing the search leaves, his invited team leaves with him.
IV. While removing a user from a squad, the system considers the auto-invites and the group invites of the user.
V. In case after doing this the format falls below the permissible range, then that squad would be cancelled

In an embodiment of the system, the user has the option to leave a Match or sports event after the Match or sports event is active. In this case the system starts performing a replacement search as explained below, and auto-invites are sent by the system (explained previously) and all the remaining users are given a chance to Invite somebody from their list to fill in the empty spot:
a) User can select multiple people together from the list and send the invite
b) The invite will only show the following details on the Match or sports event Ticket:
   I. Date
   II. Time
   III. Recommended Location
   IV. Format

The user is not allowed to invite anyone if time range of the Match or sports event coincides within +/−3 hrs of a prescheduled match or sports event of the targeted person.

As soon as the system receives the required acceptances, the remaining invites will expire and Match or sports event will proceed on.

In case of a Group Search, once the user who initiates the search accepts the Match or sports event, then each invited player becomes an individual player with the preferences of the user who initiates the search (except Age and Gender) for the system record and is considered as an individual by the system.

If at any point the Match becomes completely empty with no active player in the Match, then the Match itself will expire and subsequently all the pending invitations also expire.

If the system does not find a replacement 15 mins before the Match time, then the Match becomes incomplete.

In case of an incomplete match,
a. The match continues
b. If the total number of players falls below 7, then the Match is cancelled due to insufficient number of players.
c. Players ratings take place but match result procedure do not take place

In an embodiment of the present invention, the system initiates a replacement search when a player leaves a confirmed match or sports event.

In the replacement search, the system shortlists all the people from the available pool who meet the restriction parameter as per the other squad members and the proposed match or sports event parameters. Thereafter, the system removes those players from this filtered pool, who have already rejected or left this match or sports event (even if it is a Group Invite) and put them in a rejected pool.

In case if a user has previously rejected an Auto-invite and the same person comes to the Available pool then system considers the person in available pool of players.

The system then makes squad combinations for the remaining people from the final filtered pool and proposes the highest scoring squad.

In case of a Group search, the replacement search can optionally be filling-in individuals/players.

After the match or sports event is accepted by the user who initiated the group search, then all the group members are considered as individual members.

In an embodiment of the present invention, the system allows the users to chat with each other once a match or sports event is active. The users can send/receive messages, share photos or location or contact. Once a match or sports event is active, the users are allowed to create Team Chatroom/Entire Squad Chatroom and also initiate individual chats.

Users may use chats to suggest venues to each other in an active match or sports event:
a. During an Active chat, a user can propose a Venue from the list for other people to view.
b. In case the Venue is a Private Property, then the user can also propose this Venue over the discussions in the Chats and for the record it will be called “Private” under the Venue in the Match or sports event details

The system further provides the user with the option to contact the company through Chat itself with any feedback/issues/complaint. The system maintains proper record of all communication with the company and responds to issues over chat itself

In an embodiment of the present invention, the users have an option to Add Match or sports event venues on their own along with basic details and pictures, which then become a public information on the system for any other user to view or even select for his own match or sports event. Any user can add match or sports event venue by entering following options:
I. Name
II. Location (with Exact Lat/Long)
III. Nearest Landmark (Optional)
IV. Picture (Optional)

Once a user enters a new venue, the system checks for all the available venues within 1 KM radius of the location of the new venue and shows it to the user.

In case, the user is trying to re-register the same venue again then he will have the option to cancel. The option to cancel lies with the user only.

Users will also have the option to rate a venue/location and also post comments:
a. User can Rate the Venue out of 5 stars
b. User can change his rating for the same as many times and the system will update accordingly
c. Users can also post comments about the venue

Users will have an option to maintain a separate list of their favorite venues, this will be used for Auto-invite purpose.

User can View/Add/Delete Venues from his Favorite List also

User will also have an option to Report any Venue for various reasons

Further, the system also maintains a history of each user of his past match or sports events along with match or sports event details and the players he has played with.

There will be a Match or sports event History section on the system for each user, where he can go and view his past match or sports event.

The user will also have the option to contact any or all of the players he played with and can also start forum discussions about the Match or sports event.

Any user can also propose for a re-match here with the same team members.

The system is further configured to ask for a compulsory feedback of each player from one another after the match or sports event and maintain the rating of each player based upon this feedback.

The system randomly asks the user to rate one player out of 5 stars, which will be selected by the system.

In case of a finished or already occurred sports event, the system randomly selects players from the same team to be rated.

In case of an incomplete sports event, the system randomly asks anyone from the entire squad.

The system 100 conducts the rating process such that a player is rated at least once and there is no cross rating (i.e. players rating each other).

In case if the user decides to skip this step, then he will be warned that in this case his own rating will also be nullified.

In either case if the notifications still pending after 3 hours, then it will expire then the rating of the user will get nullified.

A person can organize another match even if he has not responded to the ratings notification of the previous match.

After this, the user will have an option to rate more players as per his own selection in case he wishes to do so.

User will be notified about his rating after the Match or sports event, but will not be shown who has rated him. This rating will be shown in the player profile and will be visible to everyone.

The average of all the ratings received for a user will be shown on his profile page, which will be visible to public.

In an embodiment of the present invention, the system calculates reliability rating of a user/player based upon his punctuality, attendance and responsiveness on the system.

The Reliability rating of a user/player will be automatically calculated by the system and shown alongside the other rating in a percentage format.

Reliability rating will depend upon two things:
i. A user's attendance for a confirmed match or sports event
ii. User's responsiveness in responding to various communications done between the system and him

The system has a manual CheckIn feature to automatically register the attendance of the player.

For a scheduled match or sports event, the system automatically sends a notification to the player at the time of the Match or sports event to Check-in.

When the user does the Check-in, the system automatically takes its current location and compare the distance with the Venue Location of the Match or sports event

If the current location is within 0.25 KM radius of the Venue location, then the attendance will be marked as present and the user will be informed.

In case the current location is outside this range, then the user will be informed and will be given the option to ReCheck-in later.

In case the Venue location is “Private”, then the first person's check-in location is considered as the Venue location.

The check-in feature will remain active for the next 3 hours after the check-in of the second person. Once the second person checks in, then the system assumes that the match is occurring at the venue. Subsequently, the Match or sports event time is updated the same as the second person's check-in time.

In case, there is no CheckIn, then the CheckIn will remain active for the next 3 hours after the original Match or sports event Time.

The user will have the option to cancel the match or sports event any time before Check-In. However, if he tries to cancel after the second person's check-in time, then he is considered as “No Show”.

User will have the option to End Match or sports event, which will automatically activate after a user successfully, Checks-In.

As soon as a user ends a Match or sports event, he will be able to schedule another Match or sports event.

In case of “No Show”:
a. Even if there is one No Show, only Player ratings will be done for those who checked-in and No Match or sports event result and No Match or sports event Played will be updated for anyone
b. However, for the people who didn't show up there will be no ratings and no match or sports event result or match or sports event played updated

Once a match or sports event is over, Post-match activities (Ratings and Match or sports event Result) start 3 hours after the updated Time of the Match or sports event or as soon as the system gets all the required Checks-in and subsequent End Match or sports events are done.

In case there is no single Check-in, then the Match or sports event is considered as nullified.

Ratings will be done as per the below table:

| Score | 5 | 4 | 3 | 2 | 1 |
|---|---|---|---|---|---|
| Attendance | Show | | | | No Show |
| (w 1 = 0.75) | | | | | |
| Responsiveness | 0-5 mins | | 5-30 mins | Above | No Response |
| (w 2 = 0.25) | | | | 30 mins | |

In an embodiment of the present invention, a user can interact with any other player, and can select him/her from the database and send message.

A user can however, create and maintain Group of friends for his own contact management
No approval is required to be added to the Group
A user can send a message to the entire group at once, and at this point other users will receive the message and can see the other members of the Group
While searching a player to invite for a sports event, if the user is a member of any group of the user then it the system provides some distinct sign to highlight this

The method and system described above have numerous advantages. The disclosed teachings provide features for easily find a sports event along with required number of players for playing the sports event in a real time scenario.

The system, as described in the disclosed teachings or any of its components, may be embodied in the form of a computer system. Typical examples of a computer system include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer.

In a computer system comprising a general-purpose computer, such may include an input device, and a display unit. Specifically, the computer may comprise a microprocessor, where the microprocessor is connected to a communication bus. The computer may also include a memory. The memory may include Random Access Memory (RAM) and Read Only

Memory (ROM). The computer system further comprises a storage device, which can be a hard disk drive or a removable storage drive such as a floppy disk drive, optical disk drive, and the like. The storage device can also comprise other, similar means for loading computer programs or other instructions into the computer system.

The computer system may comprise a communication device to communicate with a remote computer through a network. The communication device can be a wireless communication port, a data cable connecting the computer system with the network, and the like. The network can be a Local Area Network (LAN) or a Wide Area Network (WAN) such as the Internet and the like. The remote computer that is connected to the network can be a general-purpose computer, a server, a PDA, and the like. Further, the computer system can access information from the remote computer through the network.

It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatus configured to implement the method are within the scope of the present invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

We claim:

1. A computer implemented method for organizing and identifying a sports event for a user based on user preferences in an online networking platform having a plurality of players associated with a plurality of devices, the computer implemented method comprising:
retrieving a preferred set of parameters corresponding to the user from a user device or from those stored in the online networking platform;
retrieving at least one suitable player from a database comprising plurality of players, the at least one suitable player retrieved based on the user preferences and the set of parameters corresponding to the user;
proposing the sports event to the user and the atleast one suitable player on the associated plurality of devices for playing the sports event; and
allowing the user and the at least one suitable player to play the sports event in a real world scenario on the basis of the proposed sports event.

2. The computer implemented method as claimed in claim 1, wherein the preferred set of parameters is at least one of preferred location of the user, and date and time of sports event.

3. The computer implemented method as claimed in claim 2, wherein the preferred location selected by the user is a home location of the user.

4. The computer implemented method as claimed in claim 1 further comprising calculating reliability rating of the user based upon predefined criteria upon conclusion of the sports event.

5. The computer implemented method as claimed in claim 4, wherein the reliability rating of the user is calculated on the basis of the user's attendance at the sports event and the user's responsiveness.

6. The computer implemented method as claimed in claim 1 further comprising sending auto-invites to the players for attending the sports event.

7. The computer implemented method as claimed in claim 6, wherein the auto-invites are sent to the players who are physically located within a predetermined distance from the preferred location.

8. The computer implemented method as claimed in claim 7, wherein the predetermined distance is less than 1 kilometer (KM) distance from the preferred location of the user.

9. The computer implemented method as claimed in claim 6, wherein the auto-invites are sent to the players who have their favorite venue within a predetermined distance of the preferred location.

10. The computer implemented method as claimed in claim 9, wherein the auto-invites are sent to players who have their favorite venue within 1 KM distance of the preferred location.

11. The computer implemented method as claimed in claim 6, wherein the auto-invites are sent when there are at least a predetermined number of idle users.

12. The computer implemented method as claimed in claim 11, wherein the auto invites are sent when there are at least 8 idle users.

13. The computer implemented method as claimed in claim 6, wherein the sending of auto-invites to one or more players works together with the search conducted for retrieving the at least one suitable player.

14. The computer implemented method as claimed in claim 2, wherein the preferred location is a private venue.

15. The computer implemented method as claimed in claim 1 further comprising performing a group search, wherein a plurality of users search for suitable players based on predefined criteria.

16. The computer implemented method as claimed in claim 1 further comprising performing a replacement search to search for a replacement player when the retrieved at least one suitable player has cancelled participation to the sports event.

17. The computer implemented method as claimed in claim 2, wherein the preferred location is a favorite venue of the user.

18. The computer implemented method as claimed in claim 1 further comprising maintaining a history of results of the occurred sports event.

19. The computer implemented method as claimed in claim 1, wherein the preferred set of parameters is entered by the user.

20. The computer implemented method as claimed in claim 1 comprising issuing tickets to the user and the atleast one suitable player for playing the sports event on acceptance of the invitation.

21. The computer implemented method as claimed in claim 1 comprising receiving a checking in input from the user after the user reaches a venue for the proposed sports event.

22. The computer implemented method as claimed in claim 1 further comprising recommending a venue for a sports event to the user and the players for playing a sports event.

23. The computer implemented method as claimed in claim 22, recommending the venue is based on the location of the user and the players.
